(19) United States
(12) Patent Application Publication
(10) Pub. No.: US 2003/0140257 A1
(43) Pub. Date: Jul. 24, 2003

(54) Encryption, authentication, and key management for multimedia content pre-encryption

(76) Inventors: Petr Peterka, San Diego, CA (US); Alexander Medvinsky, San Diego, CA (US); Kuang-Ming Chen, San Diego, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/349,263

(22) Filed: Jan. 21, 2003

Related U.S. Application Data
(60) Provisional application No. 60/350,687, filed on Jan. 22, 2002.

(51) Int. Cl. H04L 9/00

(52) U.S. Cl. 713/201

(57) ABSTRACT

A method and system for transmitting content from a content provider to a caching server and then from the caching server to a viewer. The method comprises encrypting the content with a pre-encryptor application before the content is transmitted to the caching server. The pre-encryptor application uses a pre-encryption subkey provided by a key storage service to perform the pre-encryption. The key storage service is a stand-alone component of the system and generates, stores, and distributes the pre-encryption subkeys.

### RELATED APPLICATIONS

The present application claims priority under 35 U.S.C. § 119(e) from the following previously-filed Provisional Patent Application, U.S. Application No. 60/350,687, filed Jan. 22, 2002 by Petr Peterka et al., entitled “Encryption, Authentication and Key Management for Multimedia Content Pre-Encryption,” and which is incorporated herein by reference in its entirety.

### BACKGROUND

Every day hundreds of thousands of people interact electronically. For example, people use electronic mail (e-mail) to correspond with one another and to send information. People and businesses rely heavily on networks of computers or other electronic devices to manage, protect, and transfer important information. Millions of dollars are electronically transferred daily via bank networks and automatic teller machines (ATMs). People use cellular phones and other wireless personal digital assistants (PDAs) to communicate and transfer information on a daily basis.

The advent of the Internet, comprised of millions of interconnected computers, has accelerated electronic interaction dramatically. The Internet allows nearly instantaneous communication and transfer of information to virtually anywhere in the world. The World Wide Web (www) is used for online business, data distribution, marketing, stock exchange, online banking, gaming, research, learning, and a myriad of other activities.

When parties interact face to face or by using a physical medium such as paper, it is relatively easy to authenticate the credentials of those who are interacting. For example, if a person walks into a bank and tries to make a withdrawal, the bank teller can ask for and verify his or her identification before giving the requested funds. A person's signature on a contract is considered sufficient to guarantee his or her approval of the contract. Likewise, if a person goes into a store and buys an item with a credit card, it is easy for a cashier to take precautions so as to be reasonably sure that the person is the true owner of that credit card.

However, in the realm of electronic interaction, such physical means of authentication cannot be used. People and businesses will not transfer funds, buy an item over the Internet, or otherwise manage and transfer confidential information using any electronic device unless they feel that their electronic interactions are secure and safe. Thus, in a world where decisions and agreements are communicated electronically, electronic techniques for providing authentication, security, and privacy are needed.

Cryptography is the study of techniques and applications that can be used to protect sensitive information, maintain privacy in communications, authenticate users in transactions, and perform other security measures in information transfer. Cryptanalysis is the study of how to compromise, or defeat, cryptographic mechanisms. A hacker, for example, is a person who studies and practices cryptanalysis. Cryptology is the discipline of cryptography and cryptanalysis combined.

Cryptography allows people to carry over the confidence found in the physical world to the electronic world, thus allowing people to do business electronically without undue worries of deceit, breaches in privacy, or lack of security. The perpetual increase of information transmitted electronically has led to an increased reliance on cryptography.

For example, cryptography techniques help make web sites secure and electronic transmissions safe. This allows people to do online banking, online trading, and make online purchases with their credit cards without worrying that their account information is being compromised. Cryptography is very important to the continued growth of the Internet and electronic commerce.

Cryptography is also used in phones, televisions, and a variety of other common household items. Without cryptography, hackers could much more readily access someone else's private e-mail, listen in on phone conversations, tap into cable companies and acquire free cable service, or break into bank accounts.

A major emphasis in cryptography includes encryption and decryption. Encryption is the transformation of data into a form that is apparently unintelligible and extremely difficult, if not impossible to access in a reasonable amount of time without the appropriate knowledge, e.g., an electronic key (key). Keys will be explained further below. Encryption's purpose is to ensure privacy by keeping information hidden from anyone for whom it is not intended, even those who have access to the encrypted data. Decryption is the reverse of encryption; it is the transformation of encrypted data back into an intelligible form. For a web site to be secure, for example, all of the data transmitted between the computers where the data is stored and where it is received must be encrypted. The receiving computers must then be capable of decrypting the data.

As explained above, successful encryption and decryption depend on some sort of secret knowledge ideally known by only the parties performing the encryption and decryption. This piece of knowledge is referred to as a key. A key is usually a sequence of random or pseudorandom bits. Thus, a person without the right key cannot send, receive, or interpret someone else's sensitive information. Keys are also used for electronic authentication, digital signatures, digital timestamps, and for other electronic security purposes.

Advances in electronic communication technology have resulted in the capability and desirability to download and/or stream multimedia content over the Internet through Internet Protocol (IP) networks such as the HyperText Transfer Protocol (HTTP), the Real Time Protocol (RTP), and the Real Time Streaming Protocol (RTSP). If content is downloaded, it is transferred in its entirety from a content provider to the customer's device before it is viewed, used, or heard by the customer. On the other hand, if content is streamed, a customer does not have to wait to completely download the content before viewing, using, or hearing it. Rather, streamed content is transmitted as a sequence of packets that can be viewed, used, or heard as they arrive. The user needs a viewer or player application capable of playing the streamed content. Examples of multimedia content that can be streamed and/or downloaded from a content provider to a customer's electronic device (e.g., personal computer) via the Internet include video on demand (VOD), live video and audio broadcasts, software, e-books, movies, and music. As used hereafter and in the appended claims, unless otherwise specifically denoted, the term “content” will be used to refer expansively to all possible digital content that can be streamed or downloaded, including, but not limited to, multimedia content and electronic documents.

There is obviously a need for secure delivery of content to legitimate customers. Thus, a content provider must encrypt the content that it sends over the Internet. Traditionally, content providers encrypt content in real time as it is delivered to the customer. However, it is not always desirable or feasible for a content provider to encrypt its content in real time. Thus, there is a need in the art for content providers to be able to encrypt content before it is transmitted over the Internet as opposed to encrypting it in real time. Encrypting content before it is transmitted for download or streaming is called off-line encryption or pre-encryption. Pre-encryption would reduce cost and overhead that are associated with real time encryption. There is also a need in the art for key management and distribution associated with pre-encryption.

### SUMMARY

In one of many possible embodiments, the present invention provides a method of transmitting content from a content provider to a caching server. The caching server then distributes the content to a viewer. The method comprises encrypting the content with a pre-encryptor application before the content is transmitted to the caching server. The pre-encryptor application uses a subkey provided by a key storage service to perform the pre-encryption.

Another embodiment of the present invention provides an internet protocol rights management system for managing transmission of content from a content provider to a caching server and then from the caching server to a viewer. The system comprises a pre-encryptor application for encrypting the content before it is transmitted to the caching server. It also comprises a stand-alone key storage service for generating, storing, and distributing subkeys. The subkeys are used by the pre-encryptor application to encrypt the content. They are also used by the caching serve to decrypt the content after it is encrypted and transmitted to the caching server.

### BRIEF DESCRIPTION OF THE DRAWINGS

The accompanying drawings illustrate various embodiments of the present invention and are a part of the specification. The illustrated embodiments are merely example of the present invention and do not limit the scope of the invention.

FIG. 1 is an exemplary content delivery architecture that can be used to implement an embodiment of the present invention.

FIG. 2 illustrates a preferable IPRM architecture that provides secure streaming or download of content from a content provider to a viewer via a catching server.

FIG. 3 illustrates an exemplary IPRM architecture that includes a pre-encryption application and its related key management and distribution system.

FIG. 4 is a flowchart that details an exemplary pre-encryption method and its related key management and distribution method that can be used to implement an embodiment of the present invention.

FIG. 5 is a flowchart that illustrates an exemplary method whereby a subkey that is associated with a particular piece of pre-encrypted content is retrieved by a catching server so that the pre-encrypted content can be decrypted.

Throughout the drawings, identical reference numbers designate similar,but not necessarily identical, elements.

### DETAILED DESCRIPTION

The present specification describes a method and system whereby a content provider encrypts its content off-line using a separate pre-encryptor application that is not integrated with its streaming and content file servers. The specification also describes a method and system of key management and distribution associated with the pre-encryption.

The pre-encryption and key management and distribution methods and systems embodied in an Internet Protocol Rights Management (IPRM) system. An IPRM system provides digital rights management functions such as authentication, privacy, security, integrity, and access control to any multimedia downloading or streaming network based on IP protocols. For example, a preferable IPRM system supports point-to-point delivery, such as video on demand (VOD), and multicast delivery of content. A preferable IPRM system also encompasses persistent access issues. Persistent access is defined as access to a local copy of the content that the customer has received and saved in local persistent storage (e.g., on a hard disk). Persistent rights include playback or rendering of content, copy protection, redistribution to other users or devices, printing rights, etc.

An exemplary IPRM system is based on software protection, with a limited trust placed upon the clients. However, an IPRM system can be enhanced with an optional hardware security module. In some applications, this hardware security module may be mandatory to obtain rights to high quality content from copyright owners requiring high security levels.

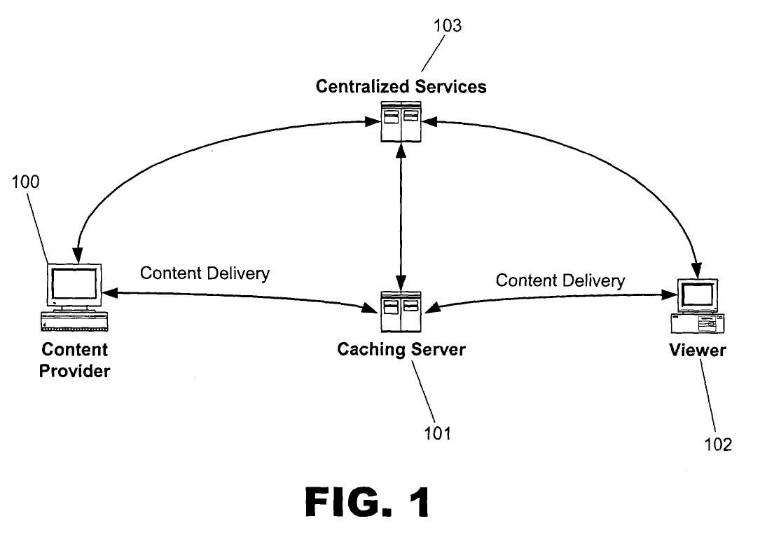

FIG. 1 is an exemplary content delivery architecture that can be used to implement an embodiment of the present invention. As shown in FIG. 1, a content provider (100) delivers content to a viewer (102) via a caching server (101). As used hereafter and in the appended claims, unless otherwise specifically denoted, the term “caching server” denotes any type of server that is capable of delivering content to viewers using any desired streaming or file transfer protocol, either over point-to-point or multicast connections. According to an embodiment of the present invention, the delivery can either be in the form of a content download or a content stream. The viewer (102) preferably comprises an application capable of displaying, broadcasting, and managing the downloaded or streaming content and is preferably run on a host, such as a personal computer (PC), server, or some other type of electronic device. The viewer (102) is preferably operated by a customer, or client.

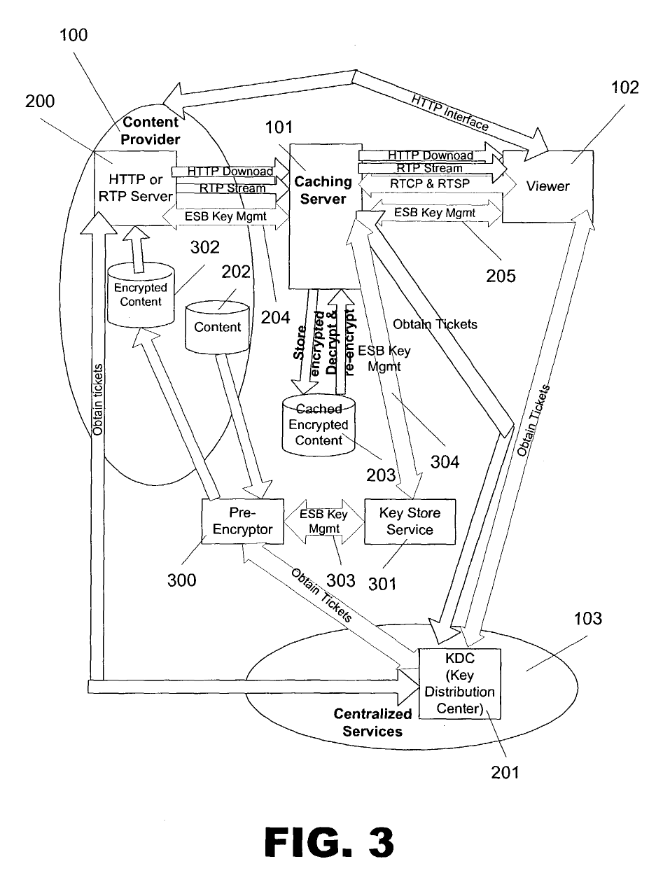

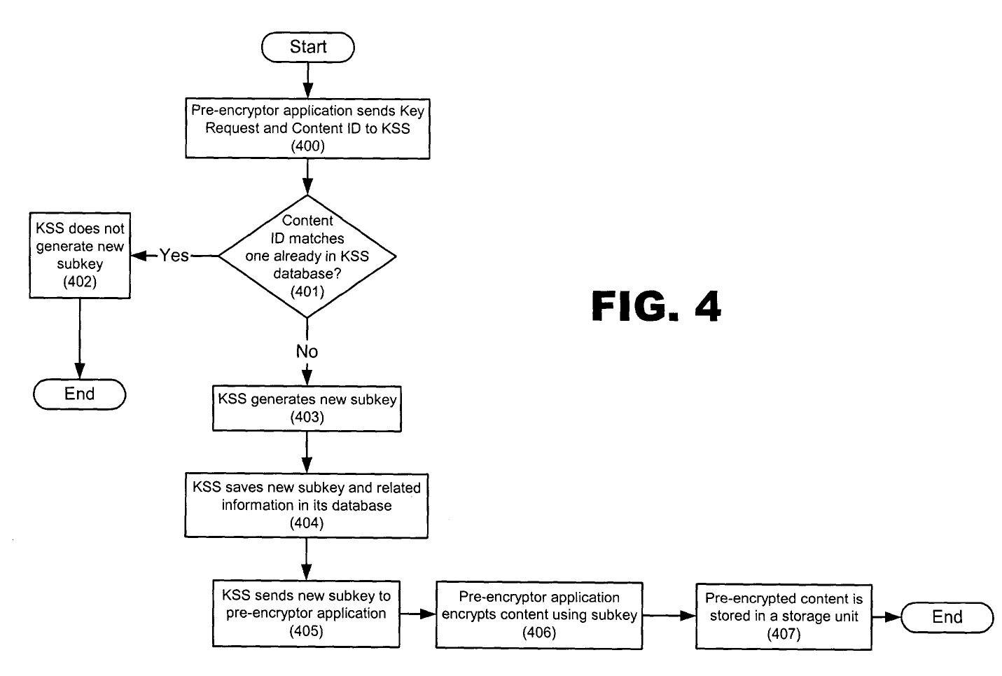

The content provider (100) in the exemplary architecture of FIG. 1 can provide any of a number of multimedia content services. For example, the content can be VOD, pay-per-view (PPV), pay-by-time (PBT), pay-by-quality (PBQ), streaming video or audio, etc. According to an embodiment of the present invention, the content provider (100) pre-encrypts the content that it streams to the viewer (102) via the caching server (101). The pre-encryption method and its related key management and distribution method will be explained in more detail in connection with FIG. 3 and FIG. 4.

As shown in FIG. 1, the content provider (100) preferably provides the content to a caching server (101), which in turn delivers the content to the viewer (102). The caching server (101) is used to move the content closer to the edges of the network. This improves the streaming and download performance and allows smaller content providers to sell their content without the need to buy expensive hardware for media streaming. It also allows introduction of an IP multicast only at the caching servers (101). A multicast is when the same content is delivered to one or more customers at the same time. Although the use of caching servers (101) is preferable, it is not necessary. Another embodiment of the present invention is for the content to be streamed directly from the content provider (100) to the viewer (102). However, for explanatory purposes, this specification assumes the presence of some type of caching server (101).

The preferable content delivery architecture of FIG. 1 also shows that each element of the content delivery system gets provisioned with centralized services (103). Centralized services (103) preferably include key management and distribution services. As shown in FIG. 1, each element of the content delivery system can preferably communicate with centralized services (103). For example, as will be explained in more detail below, the viewer (102) can request a ticket from centralized services (103) so that it can be authenticated and authorized to receive content from the caching server (101).

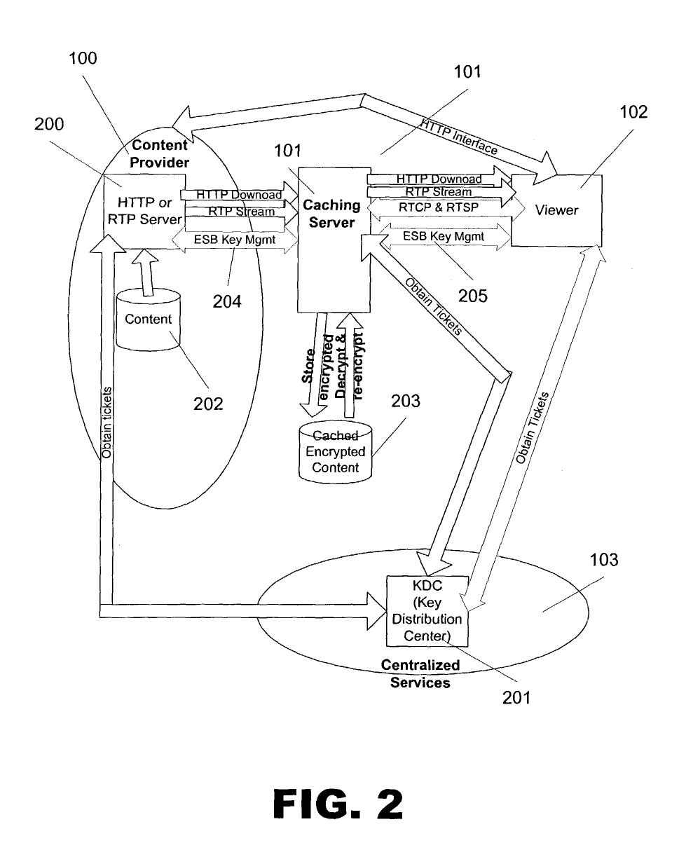

FIG. 2 illustrates a preferable IPRM architecture that provides secure streaming or download of content from a content provider (100) to a viewer (102) via a caching server (101). As shown in FIG. 2, the content provider (100) preferably comprises an HTTP or RTP server (200). The content provider (100) preferably also comprises a storage unit (202) containing content. The storage unit (202) can be a hard drive or any other device capable of storing content. The HTTP or RTP server (200) preferably has access to the storage unit (202) containing content that is to be transmitted to the viewer (102). The content can be hinted content according to one embodiment of the present invention. Hinted content is content that contains hint tracks, or information that enables the content to be streamed. However, the content does not necessarily have to be hinted.

As shown in FIG. 2, the content provider's HTTP or RTP server (200), the caching server (101), and the viewer (102) each communicate with and obtain tickets from a key distribution center (KDC) (201), which is preferably a part of the centralized services (103), through the use of an IPRM key management interface. As used hereafter and in the appended claims, unless otherwise specifically denoted, a KDC will refer to any centralized service that creates, manages, and distributes tickets comprising keys that allow secure communication between the content provider (100), the caching server (101), and the viewer (102). This secure communication facilitates the delivery and decryption of the encrypted content. The IPRM key management interfaces are represented in FIG. 2 by the shaded arrows. As shown in FIG. 3, the key management interface (204) is key management between the HTTP or RTP server (200) and the caching server (101) where keys are created that are unique to this interface and where content is encrypted each time it is being sent to the caching server (101), even when the same content is sent multiple times. The key management interface (205) is key management between the caching server (101) and the viewer (102) and is used to obtain keys that are required to encrypt and decrypt content sent to the viewer (102).

The IRPM key management interface requires a protocol that is capable of scaling to potentially millions of users and interfacing with a centrally administered and possibly distributed database, such as the KDC (201). An exemplary, but not exclusive, protocol is the Electronic Security Broker (ESBroker) protocol. The ESBroker protocol is based on a Kerberos framework and consists of client interactions with the KDC as well as with individual application servers, such as the content provider's server (200) and the caching server (101). These interactions preferably use both public key and symmetric key algorithms. However, protocols other than the ESBroker protocol can also be used. The ESBroker protocol or any other protocol that is used is preferably generic and easily adaptable to different applications that require authentication and encryption in a distributed environment. As used hereafter and in the appended claims, unless otherwise specifically denoted, the ESBroker protocol will be used to refer to any possible protocol that can be used in the IPRM key management interface.

As previously mentioned, the KDC (201) distributes tickets. A ticket is a record that helps a client to authenticate itself to a server. A preferable ticket contains the client's identity, a session key, a timestamp, and other information. All this information is sealed using the server's secret key. For example, the viewer (102) must communicate with the KDC (201) in order to obtain a ticket that is then presented to the caching server (101) for mutual authentication. If the caching server (101) determines that the ticket is a valid ticket, the content can be successfully streamed to the viewer (102).

According to an embodiment of the present invention, the use of tickets is a central part of the ESBroker key management protocol. In FIG. 2, the viewer (102) and the content provider server (200) are both clients of the caching server (101). In addition, the caching server (101) could be a client of other caching servers for moving content between caching servers. Therefore, all entities in FIG. 2 preferably obtain tickets from the KDC (201).

As shown in FIG. 2, ESBroker key management protocol (204, 205) is preferably used to establish a secure session between the content provider's server (200) and the caching server (101) and between the caching server (101) and the viewer (102). After the secure sessions are established, messages transferred between the content provider's server (200) and the caching server (101) and between the caching server (101) and the viewer (102) can be encrypted and/or authenticated. Each new secure session preferably has its own unique set of keys that are only shared between two hosts such as the viewer (102) and the caching server (101), for example. The keys are preferably not shared between multiple secure sessions even if they are between the same two hosts.

FIG. 2 shows an exemplary RTP stream from the content provider's server (200) to the caching server (101) and also from the caching server (101) to the viewer (102). According to an embodiment of the present invention, these RTP streams are encrypted and can optionally be authenticated. FIG. 2 also shows the RTCP and RTSP control traffic associated with the RTP stream between the caching server (101) and the viewer (102). This control traffic is also preferably encrypted and/or authenticated to provide customer privacy and protection from protocol manipulation attacks that could cause denial of service. Also shown in FIG. 2 is an exemplary HTTP download from the content provider's server (200) to the caching server (101). There can also be an HTTP download from the caching server (101) to the viewer (102). These HTTP downloads are also preferably encrypted and/or authenticated.

As shown in FIG. 2 is an exemplary HTTP interface between the viewer (102) and the content provider (100). This HTTP interface is optional and can be used for content browsing, selection, and a “content buy” screen, for example. This HTTP interface is also preferably protected by encryption and/or authentication. Protection is not needed in order to provide conditional access to content. However after a customer has confirmed a buy of content, for example, his or her selection and associated content rules need to be cryptographically protected from tampering in order to prevent customers from changing their selection or its associated cost. Thus, the content provider (100) preferably returns the user selection and content rules in a cryptographically protected object called a Session Rights Object (SRO). In order to protect the SRO, the content provider (100) preferably obtains a ticket for the selected caching server (101) even though there may not be any key management messages exchanged directly between these two entities.

FIG. 2 also shows a preferable interface between the caching server and its database (203). As shown in FIG. 2, the database (203) preferably stores or caches encrypted content. All content stored in the database is preferably encrypted. However, as shown in FIG. 2, the encrypted content that is cached in the database (203) is preferably decrypted by the caching server (101) and then encrypted again by the caching server (101) before it is delivered to the viewer (102).

A preferable method of pre-encryption and its associated key management and distribution will now be explained in connection with FIG. 3. FIG. 3 illustrates an exemplary IPRM architecture that has pre-encryption capability. The IPRM key management interface is represented by the shaded arrows. As shown in FIG. 3, the content provider (100) preferably comprises a storage unit (202) containing content that is to be downloaded or streamed to the viewer (102). The content is first encrypted with a pre-encryptor application (300) that is preferably operated by the content provider (100). The pre-encryptor application (300) can be located in the content provider (100) or it can be located on a separate host. After the content has been encrypted, it is stored in another storage unit (302). In some applications, this storage unit (302) is the same storage unit (202) that was used to store the content that has not yet been encrypted. The storage unit (302) now comprises content that has already been encrypted by the pre-encryptor application (300), as shown in FIG. 3. The storage unit (302) can be any type of storage device such as a hard drive. Another embodiment of the present invention provides for a method whereby the pre-encryptor application (300) encrypts and hints the content before storing it in the storage unit (302). In this case, the storage unit (302) would contain hinted encrypted content.

FIG. 3 illustrates that the pre-encryptor application (300) preferably performs ESBroker key management (303) with a key store service (KSS) (301) in order to create and store the keys that are used for the content pre-encryption. The KSS (301) is preferably a stand-alone component responsible for assigning keys for pre-encryption of particular content, storing these keys permanently, and distributing them to the caching server (101) upon request. The caching server (101) is able to then decrypt the content that is pre-encrypted with the use of these keys. The keys used for pre-encryption are, in the case of ESBroker protocol, derived from subkeys. A subkey is a secret value that is returned by a server in an ESBroker Key Reply message. In the exemplary scenario of FIG. 3, this server is the KSS (301). Kerberos has a similar concept of a subkey, where a subkey can be delivered in a Kerberos AP Reply message. As used hereafter and in the appended claims, unless otherwise specifically denoted, the terms “pre-encryption subkey” and “subkey” will be used interchangeably to refer to a subkey that is generated by the KSS (301) to derive keys that are used in the pre-encryption and authentication of content, as well as in the decryption and integrity validation of this pre-encrypted content.

The KSS (301) is located at the content provider (100) site where the content is stored and pre-encrypted according to one embodiment. According to another embodiment, the KSS (301) is located in a central location not shown in FIG. 3. Yet another embodiment is that the KSS (301) resides on the same host as the pre-encryptor application (300). The content provider (100) preferably encodes the location of the KSS (301) in the SRO that is transmitted to the viewer (102) so that the caching server (101) knows where to obtain the correct subkey.

The pre-encryption subkeys are preferably stored in a relational database in the KSS (301). The database interface is preferably open database connectivity (ODBC), which allows the interoperation of a variety of relational database engines. The pre-encryption subkeys that are stored in the database are preferably encrypted and authenticated using the same technique that the KDC (201) uses to encrypt and authenticate the keys that it generates and distributes. The database preferably maintains a record for each piece of pre-encrypted content with the following fields: (1) the content identification or identifier (ID), (2) the encrypted subkey, (3) the selected encryption and authentication algorithms, and (4) the authenticator. The content ID is an identifier that is unique for a particular KSS (301). Each piece of content has its own content ID. For example, the content ID can be its uniform resource locator (URL) or universal resource identifier (URI). The exact method of deriving the content ID will depend on the particular application and will not be described in further detail. According to another embodiment, other fields can be used in addition to the above-mentioned fields.

As shown in FIG. 3, the pre-encryptor application (300) as well as the caching server (101) preferably request tickets from the KDC (201) in order to communicate with the KSS (301). However, if the pre-encryptor application (300) and the KSS (301) are co-located on the same host, the pre-encryptor application (300) may or may not have to request a ticket from the KDC (201) in order to communicate with the KSS (301), depending on the particular application.

When pre-encrypted content is transferred from the content provider (100) to the caching server (101) in a configuration such as that of FIG. 3, it can be transferred using a conventional file transfer protocol without any additional security in addition to pre-encryption. The caching server (101) can store pre-encrypted content as is, because it is already encrypted. When the caching server (101) begins a streaming or downloading session with the viewer (102), it uses ESBroker key management (304) in order to obtain the appropriate decryption subkeys from the KSS (301). It is important to note that the caching server (101) still performs the same ESBroker key management (205) with the viewer (102) in order to set up a secure streaming session with keys that are unique for a particular client and piece of content. Just as it is the case with no pre-encryption as described in connection with FIG. 2, during a streaming session with the viewer (102), the caching server (101) decrypts the cached encrypted content and then re-encrypts it again using a secure session set up with the viewer (102).

As shown in FIG. 3, there can be an RTP streaming session between the content provider's server (200) and the caching server (101) that is encrypted on-the-fly as opposed to being pre-encrypted. Both pre-encrypted and encrypted on-the-fly content are preferably supported in the same IPRM architecture. This is because some content, such as live content, cannot be pre-encrypted and must always be encrypted on the fly by the content provider's server (200). The content provider (100) preferably is capable of choosing whether to pre-encrypt content or to encrypt it on-the-fly.

Another embodiment entails optionally authenticating the content using a message authentication code (MAC). The MAC is appended to each pre-encrypted unit of storage of the content. The unit of storage can be a packet or a frame.

FIG. 4 is a flowchart that details an exemplary pre-encryption method and its related key management and distribution method that can be used to implement an embodiment of the present invention. It is assumed in the example of FIG. 4 that a pre-encryption application has already requested and obtained a ticket from a KDC that enables it to communicate with the KSS.

The pre-encryption method of FIG. 4 can combine a hinting process with the pre-encryption of content. The pre-encrypted and hinted content created in this scenario can later be downloaded to the caching server (101) for streaming to the viewer (102). Likewise, if the content is only pre-encrypted, the pre-encrypted content can later be downloaded to caching servers. According to an embodiment of the present invention, the content must be hinted if it is to be streamed to the viewer (102).

As shown in FIG. 4, the pre-encryption method begins with a pre-encryptor application sending a key request to a KSS (400). The key request is preferably an ESBroker Key Request message that includes a “store” action command. The key request requests the generation of a new pre-encryption subkey from which content encryption and authentication keys will be derived. The “store” action command is used because, in this case, the KSS will generate a pre-encryption subkey and then store a copy of that subkey in its database.

However, as mentioned previously, the KSS might be located on the same host as the pre-encryptor application. In this case, the key request command is preferably not sent by the pre-encryptor application to the KSS and the host performs all the functions that a remotely located KSS would perform. However, the KSS is remotely located in the example of FIG. 4. It is important to note that an IPRM system can potentially have multiple KSSs. Therefore, a content provider preferably configures its pre-encryptor application to be able to communicate with a desired KSS.

As shown in FIG. 4, the key request preferably includes the content's Content ID. Once the KSS receives the key request, it first compares the sent content ID with the content IDs already stored in its database (401). If the sent content ID does not match one of the content IDs already stored in the KSS database, the KSS generates a new subkey (403). The KSS then saves the new subkey in its database along with its related information (404). The related information preferably comprises the new content ID and selected encryption and authentication algorithms.

However, if the sent content ID does match one of the content IDs already stored in the KSS database, a new subkey is not generated (402) and the key request is rejected by the KSS. This is because it is assumed that there is a naming conflict between content that is to be encrypted and another piece of content that has already been pre-encrypted. If the content provider desires to make a change to a piece of content and then pre-encrypt it again, the content provider can define a new content ID (e.g., a URL or URI that includes a content version number). Alternatively, the content provider can utilize an administrative interface to first remove an existing entry for this content within the KSS database.

As shown in FIG. 4, after the new subkey and its related information have been stored in the KSS database, the KSS sends the new pre-encryption subkey to the pre-encryptor application (405). The selected encryption and authentication algorithms are also preferably included in this transmission. The transmission is preferably accomplished by sending an ESBroker Key Reply message.

The pre-encryptor application now pre-encrypts the content using the subkey that it received from the KSS (406). After the content is pre-encrypted, it is then preferably stored in a storage unit (407), as described in connection with FIG. 3. The pre-encrypted content is now ready for download to caching servers using a standard file download protocol without a need for any additional security applied during the content transfer.

An advantage of the key management and distribution method of FIG. 4 is that it is separated from the pre-encryption application. This allows for either co-located management of content and encryption keys or remote management of the encryption keys.

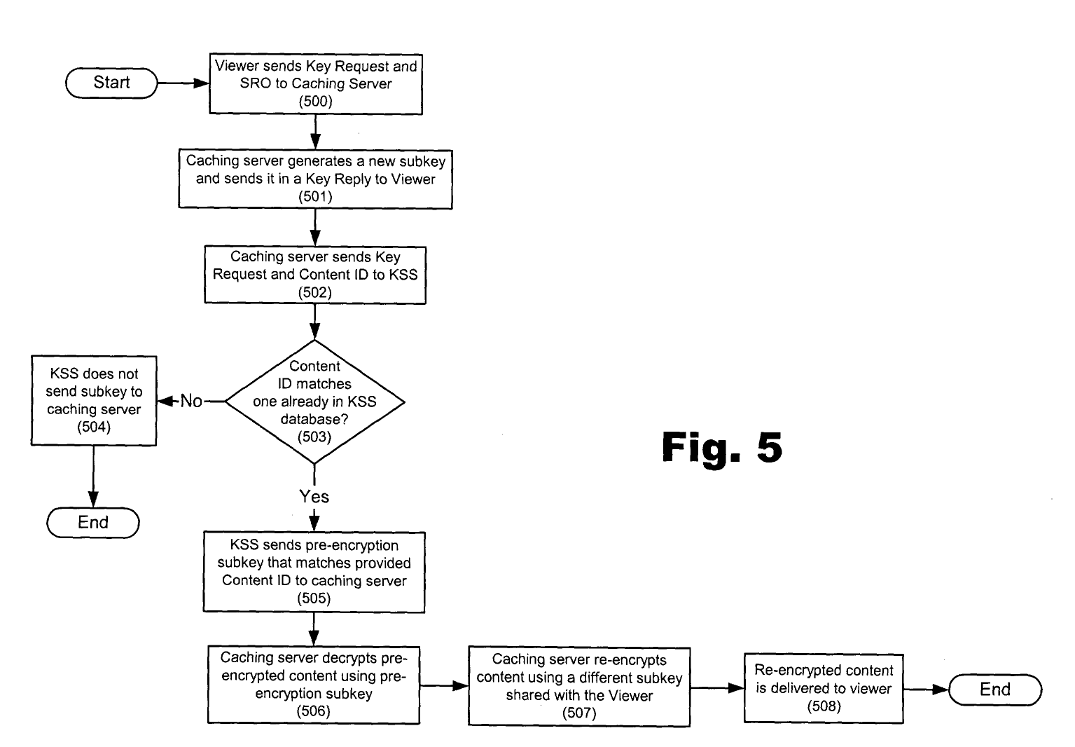

Another advantage of the present invention is that the subkeys can be permanently stored by the KSS in a database for future retrieval by a caching server. FIG. 5 is a flowchart that illustrates an exemplary method whereby a subkey that is associated with a particular piece of pre-encrypted content is retrieved by a caching server so that the pre-encrypted content can be decrypted.

The exemplary method of FIG. 5 assumes that the caching server has already downloaded a piece of pre-encrypted content from the content provider. It is further assumed in the example of FIG. 5 that the caching server has already requested and obtained a ticket from a KDC that enables it to communicate with the KSS.

The method of FIG. 5 begins with the viewer sending a key request with the viewer's ticket and SRO (Session Rights Object) to the caching server (500). The caching server evaluates the SRO and ticket and determines that this viewer is authorized to receive the requested content. The caching server then generates a new subkey that it will use to re-encrypt content delivered to the viewer and returns the subkey to the viewer (501). However, because the requested content was pre-encrypted, the caching server does not currently possess the corresponding pre-encryption subkey. Therefore, the caching server then sends a key request and content ID associated with the piece of pre-encrypted content that is to be decrypted to the KSS (502). The caching server preferably caches the pre-encryption keys locally, so that next time when another viewer requests the same content, the caching server will already have a copy of the pre-encryption subkey stored locally and will not have to send a key request again to the KSS. The key request is preferably an ESBroker Key Request message that includes a “retrieve” action command. The “retrieve” action command is used because the caching server desires to retrieve a subkey from the KSS.

As shown in FIG. 5, the key request preferably includes the content ID associated with the pre-encrypted content. Once the KSS receives the key request, it first compares the sent content ID with the content IDs already stored in its database (503). If the sent content ID does not match one of the content IDs already stored in the KSS database, no subkey is sent to the caching server (504) and the pre-encrypted content cannot be successfully decrypted.

However, if the sent content ID does match one of the content IDs already stored in the KSS database, the KSS preferably sends the subkey that is associated with the matching content ID in its database to the caching server (505). This transmission is preferably accomplished by sending an ESBroker Key Reply message. The caching server then decrypts the pre-encrypted content using the obtained subkey (506). Preferably, the subkey is not used directly to decrypt the pre-encrypted content. Instead, content decryption and authentication keys are first derived from the subkey and then used to decrypt and authenticate the content. The caching server can then re-encrypt the content and generate new Message Authentication Codes (MACs) for message integrity using a content encryption and authentication keys derived from a different subkey (507). The subkey used in this step is the same subkey that the caching server sent to the viewer in (501).

An exemplary scenario in which the preferable IPRM system that is capable of pre-encryption and key management and distribution will now be explained. This scenario will illustrate the above-described embodiments. In addition, it will entail a few additional embodiments of the present invention. In this scenario, a customer will request on-demand content from a content provider to be streamed or downloaded onto his viewer. The viewer is preferably a personal computer or any other electronic device capable of downloading content from the Internet. First, the customer contacts a search engine using a standard Internet web browser. The customer can find his desired content using this search engine. Once he has found the desired content, his viewer is redirected to the content provider.

The viewer then contacts the content provider that it was directed to and conveys its preferred list of caching servers, list of subscribed services, its ability to pay for content, and any other pertinent information as dictated by the particular application. The content provider then offers an optimized subset of purchase options that depend upon the context of the particular customer and service. For example, price selection screens can be bypassed for customers already subscribed to its service.

The content provider then preferably generates a SRO that encapsulates the purchase options selected by the consumer, an optional set of content access rules (e.g., blackout regions), and a reference to the selected content. The content provider then redirects the viewer to the appropriate caching server.

If the viewer had previously cached the relevant caching server ticket, it retrieves that ticket. If it has no cached ticket, it contacts a KDC and requests a ticket that will enable it to communicate with the caching server. In some applications, the viewer makes this ticket request by sending the KDC a Ticket Granting Ticket (TGT). The TGT is used as a token of trust to make the viewer eligible to talk to a ticket granting service (e.g., the KDC) to obtain the caching server's ticket.

The viewer then authenticates itself to the caching server using the caching server ticket. After successful authentication, the viewer forwards the SRO that it obtained from the content provider to the caching server. The caching server then checks the access rules from the SRO against the viewer's entitlements contained in the ticket. If the caching server approves the viewer's request, the viewer and the caching server negotiate a key for delivery of the content using ESBroker key management.

The viewer then starts issuing RTSP commands to the caching server to get a description of the content (e.g.; its RTSP URL) and then to request to play the content. The RTSP commands are preferably encrypted and authenticated. However, in some applications, RTSP command encryption and authentication will not be possible.

The caching server receives the RTSP commands, decodes them, and returns RTSP responses. If the viewer sends an RTSP command in encrypted form, the caching server's RTSP responses are also preferably encrypted. When an RTSP command requests to play a specific URL, the caching server verifies that the specified URL is what was specified in the SRO for the particular session.

After receiving the request to play an RTSP URL, the caching server begins to send out encrypted RTP packets and both the caching server and the viewer periodically send RTCP report packets. The RTCP packets are also preferably encrypted and authenticated, although in some applications, this is neither possible nor desirable. All the RTP and RTCP packets that are associated with the same RTSP URL are preferably encrypted using the same secure session.

Before the caching server starts sending RTP packets with encrypted payloads to the viewer, it needs to obtain a decryption key for the corresponding content. If the content provider's server delivered the content to the caching server using encryption on-the-fly, the caching server previously re-encrypted the content for local storage using a locally generated key. Thus, in this case, the caching server already possesses the decryption key that it needs to decrypt the content.

However, if the content was pre-encrypted by a pre-encryptor application, the caching server might not already have the content decryption key. If this is the case, the caching server performs the following steps to obtain it. First, it determines the location of the KSS for the pre-encrypted content. This location is either given in the SRO that was obtained from the viewer previously or it may be pre-configured manually in the caching server. Next, the caching server sends a key request message to the KSS that requests the subkey for the pre-encrypted content. This message includes the content ID. The KSS will then respond with a Key Reply message containing the pre-encryption subkey and preferably the IDs for the encryption and authentication algorithms that were used to pre-encrypt the particular content. The caching server also preferably saves a copy of this pre-encryption subkey for subsequent request from the same or other viewers for the same content.

The caching server then decrypts each RTP packet payload read in from its local storage unit using the subkey. It then re-encrypts the content using a different key that is established using ESBroker key management with the viewer. The RTP packets with re-encrypted payloads are then sent to the viewer.

The viewer then decrypts and plays the content. At the same time, the viewer may issue additional RTSP commands that may be encrypted using the same secure session. These additional RTSP commands can include commands that pause or resume the content play out, for example.

The caching server preferably keeps track of who viewed the content, how long the content was viewed, and under what mechanism the content was purchased. This information can then be used for billing purposes or for other purposes as deemed necessary by the particular application.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. A method of transmitting content from a content provider to a caching server which distributes said content to a viewer, said method comprising encrypting said content with a pre-encryptor application before said content is transmitted to said caching server, said pre-encryptor application using a pre-encryption subkey provided by a key storage service to perform said pre-encryption.

2. The method of claim 1, wherein said content provider electronically stores said content that is encrypted with said pre-encryptor application in a storage unit before said content is transmitted to said caching server.

3. The method of claim 1, further comprising:
sending a key request from said pre-encryptor application to said key storage service, said key request including a content identifier that is associated with said content; and
comparing said content identifier with content identifiers already present in a database of said key storage service;
wherein, if said content identifier does not match one of said content identifiers already present in said database of said key storage service, said key storage service generates said pre-encryption subkey, stores a copy of said pre-encryption subkey and said content identifier in said database, and sends said pre-encryption subkey to said pre-encryptor application to be used in said pre-encryption of said content.

4. The method of claim 3, wherein, before distributing said content to said viewer, said caching server decrypts said content that is encrypted by said pre-encryptor application using a copy of said pre-encryption subkey and then re-encrypts said content using a different subkey that is shared between said caching server and said viewer.

5. The method of claim 4, wherein said caching server electronically stores said content that is pre-encrypted in a storage unit before said content is decrypted and then re-encrypted and distributed to said viewer.

6. The method of claim 4, further comprising:
sending a key request from said caching server to said key storage service, said key request including said content identifier that is associated with said content; and
comparing said content identifier with said content identifiers already present in said database of said key storage service;
wherein, if said content identifier matches one of said content identifiers already present in said database of said key storage service, said key storage service sends a copy of said pre-encryption subkey that is associated with said content identifier to said caching server to be used in said decryption of said content.

7. The method of claim 6, wherein said caching server stores said copy of said pre-encryption subkey in a storage unit for future access and use.

8. The method of claim 6, wherein said content provider transmits a session rights object to said viewer, said session rights object comprising information regarding said key storage service's location.

9. The method of claim 1, wherein said pre-encryptor application hints said content.

10. The method of claim 1, wherein said content provider, said caching server, and said viewer each electronically communicate with a key distribution center to obtain tickets, said tickets comprising session keys that allow secure electronic communication between said content provider, said caching server, and said viewer.

11. The method of claim 10, further comprising using said session keys to encrypt said communication between said content provider, said caching server, and said viewer.

12. The method of claim 1, further comprising streaming said content from said caching server to said viewer.

13. The method of claim 1, further comprising downloading said content from said caching server to said viewer.

14. The method of claim 1, further comprising streaming said content from said content provider to said caching server.

15. The method of claim 1, further comprising downloading said content from said content provider to said caching server.

16. The method of claim 1, further comprising authenticating said content using a message authentication code that is appended to each unit of storage of said content.

17. The method of claim 4, wherein said viewer comprises multiple viewers that each share said different subkey with said caching server.

18. An internet protocol rights management system for managing transmission of content from a content provider to a caching server and then from said caching server to a viewer, said system comprising:
a pre-encryptor application for encrypting said content before said content is transmitted to said caching server; and
a stand-alone key storage service for generating, storing, and distributing pre-encryption encryption subkeys;
wherein said key storage service generates a pre-encryption subkey that is used by said pre-encryptor application to encrypt said content and by said caching server to decrypt said content after it is encrypted and transmitted to said caching server.

19. The system of claim 18, wherein said content provider comprises:
a server for electronically communicating with said caching server and said viewer; and
a storage unit for electronically storing said content that is encrypted with said pre-encryptor application.

20. The system of claim 19, wherein said storage unit is a hard drive.

21. The system of claim 19, wherein said pre-encryptor application sends a key request to said key storage service, said key request comprising a content identifier that is associated with said content.

22. The system of claim 21, wherein said key storage service compares said content identifier with content identifiers already stored in a database of said key storage service.

23. The system of claim 22, wherein if said content identifier does not match one of said content identifiers already stored in said database of said key storage service, said key storage service generates said pre-encryption subkey, stores a copy of said pre-encryption subkey and said content identifier in said database, and sends said pre-encryption subkey to said pre-encryptor application to be used in said pre-encryption of said content.

24. The system of claim 18, wherein said caching server comprises a storage unit for electronically storing said content that is pre-encrypted and where said pre-encryption subkey is used to decrypt said pre-encrypted content.

25. The system of claim 24, wherein said caching server re-encrypts said content using a separate subkey that it shares with said viewer.

26. The system of claim 24, wherein storage unit is a hard drive.

27. The system of claim 23, wherein said caching server sends a key request to said key storage service, said key request comprising a content identifier that is associated with said content.

28. The system of claim 27, wherein said key storage service compares said content identifier that is sent from said caching server with content identifiers already present in a database of said key storage service.

29. The system of claim 28, wherein, if said content identifier sent from said caching server matches one of said content identifiers already present in said database of said key storage service, said key storage service sends a copy of said pre-encryption subkey that is associated with said content identifier to said caching server to be used in said decryption of said content.

30. The system of claim 29, wherein said caching server saves a copy of said pre-encryption subkey.

31. The system of claim 29, wherein said content provider transmits a session rights object to said viewer, said session rights object comprising information regarding said key storage service's location.

32. The system of claim 18, wherein said pre-encryptor application hints said content.

33. The system of claim 18, said system further comprising a key distribution center for generating, managing, and distributing tickets to said content provider, said caching server, and said viewer, said tickets comprising session keys that allow secure electronic communication between said content provider, said caching server, and said viewer.

34. The system of claim 18, wherein said management of transmission of content is effected with an electronic security broker protocol.

35. The system of claim 18, wherein said content comprises video on demand.

36. The system of claim 18, wherein said content is multimedia streaming content.

37. The system of claim 18, wherein said content is downloadable content.

38. The system of claim 18, wherein said content provider and said caching server authenticate said content using a message authentication code that is appended to each unit of storage of said content.

39. The system of claim 38, wherein said unit of storage is a packet.

40. The system of claim 38, wherein said unit of storage is a frame.

41. The system of claim 18, wherein said viewer comprises a host that is capable of displaying, managing, or using said content.

42. The system of claim 18, wherein said key storage service is located at said content provider's location.

43. The system of claim 18, wherein said key storage service is located on said pre-encryptor application's host.

44. The system of claim 18, wherein said caching server comprises multiple caching servers that are each capable of receiving content from said content provider.

45. The system of claim 18, wherein said viewer comprises multiple viewers that can simultaneously communicate electronically with said caching server.

46. A system for transmitting content from a content provider to a caching server which distributes said content to a viewer, said system comprising:
means for encrypting said content with a pre-encryptor application that uses a pre-encryption subkey before said content is transmitted to said caching server; and
means for generating, storing, and distributing said pre-encryption subkey with a key storage service.

47. The system of claim 46, further comprising means for electronically storing said content that is encrypted with said pre-encryptor application before said content is transmitted to said caching server.

48. The system of claim 46, further comprising:
means for sending a key request from said pre-encryptor application to said key storage service, said key request including a content identifier that is associated with said content; and
means for comparing said content identifier with content identifiers already present in a database of said key storage service;
wherein, if said content identifier does not match one of said content identifiers already present in said database of said key storage service, said key storage service generates said pre-encryption subkey, stores a copy of said pre-encryption subkey and said content identifier in said database, and sends said pre-encryption subkey to said pre-encryptor application to be used in said pre-encryption of said content.

49. The system of claim 48, further comprising:
means for decrypting said content that is encrypted by said pre-encryptor application using a copy of said pre-encryption subkey; and
means for re-encrypting said content using a different subkey that is shared between said caching server and said viewer.

50. The system of claim 49, further comprising means for electronically storing said content that is pre-encrypted in a storage unit in said caching server before said content is decrypted, re-encrypted, and distributed to said viewer.

51. The system of claim 50, further comprising:
means for sending a key request from said caching server to said key storage service, said key request including said content identifier that is associated with said content; and
means for comparing said content identifier with said content identifiers already present in said database of said key storage service;
wherein, if said content identifier matches one of said content identifiers already present in said database of said key storage service, said key storage service sends a copy of said pre-encryption subkey that is associated with said content identifier to said caching server to be used in said decryption of said content.

52. The system of claim 51, further comprising means for transmitting from said content provider to said viewer information regarding said key storage service's location.

53. The system of claim 46, further comprising means for hinting said content.

54. The system of claim 46, further comprising means for obtaining tickets from a key distribution center, said tickets comprising session keys.

55. The system of claim 46, further comprising means for streaming said content from said caching server to said viewer.

56. The system of claim 46, further comprising means for downloading said content from said caching server to said viewer.

57. The system of claim 46, further comprising means for authenticating said content using a message authentication code that is appended to each unit of storage of said content.
